(19) United States
(12) Patent Application Publication
(10) Pub. No.: US 2008/0318463 A1
(43) Pub. Date: Dec. 25, 2008

(54) LOOSE-PROOF CONNECTOR

(76) Inventors: Chang-Nan Chen, Shinjuang City (TW); Hsu-Jen Hsu, Shinjuang City (TW); Teng-Sheng Hung, Shinjuang City (TW); Jen-Yuan Hung, Shinjuang City (TW)

Correspondence Address: HDSL, P.O. BOX 220746, CHANTILLY, VA, 20153-0746, US

(21) Appl. No.: 11/767,770

(22) Filed: Jun. 25, 2007

(51) Int. Cl. H01R 13/622

(52) U.S. Cl. 439/359

(57) ABSTRACT

A loose-proof connector includes a screwing sleeve and a connecting body. The screwing sleeve is an annular body and has a circular through hole. The inner wall of the circular through hole is provided with a plurality of recessed arcs that are arranged circumferentially. The connecting body is inserted into the circular through hole of the screwing sleeve. An annular band of the connecting body is provided with protruding arcs to correspond to each recessed arc. The protruding arcs oppose to the any one of the recessed arcs and thus are adjacent thereto. Via this arrangement, the protruding arcs can bounce between any two adjacent recessed arcs, thereby generating a locking effect, and thus the loose-proof effect can be surely achieved.

### BACKGROUND OF THE INVENTION

1. Field of the Invention

The present invention relates to a connector, and in particular to a connector that has a loose-proof effect after being connected.

2. Description of Prior Art

Conventionally, a connector socket for a telecommunication line or power supply line is fitted on a wall or an electronic apparatus. A connector plug is simply inserted into the socket so as to achieve the electrical connection therebetween. With regard to this kind of conventional connector plug or socket, the inner edge of the insertion hole of the socket is provided with inner threads, and in addition, the plug is provided with a connecting piece having outer threads. Via this arrangement, when the plug is connected with the socket, the outer threads of the connecting piece can be further threadedly connected with the inner threads of the inner edge of the insertion hole, thereby achieving a firm connection.

Although the connection by means of the outer and inner threads can provide a firm connection, these threads may still rotate reversely and thus get loose if the connector plug and the socket are subject to external adverse factors, such as a long-term vibration or pulling action. Thus, the connection between the plug and the socket cannot be always kept to a satisfactory extent.

Therefore, in view of this, the inventor proposes the present invention to overcome the above problems based on his expert experience and deliberate research.

### SUMMARY OF THE INVENTION

The present invention is to provide a loose-proof connector whereby inner and outer threads having a loose-proof effect can be prevented from rotating reversely. Via this arrangement, the connection by means of threads and the loose-proof effect of the connector can be achieved.

The present invention provides a loose-proof connector including a screwing sleeve and a connecting body. The screwing sleeve is an annular body and has a circular through hole. The inner wall of the circular through hole is provided with a plurality of recessed arcs that are arranged circumferentially. The connecting body is inserted into the circular through hole of the screwing sleeve. An annular band of the connecting body is provided with protruding arcs to correspond to each recessed arc. The protruding arcs oppose to the any one of the recessed arcs and thus are adjacent thereto. Via this arrangement, when the screwing sleeve rotates on the connecting body, the protruding arcs can bounce between any two adjacent recessed arcs, thereby generating a locking effect. Such locking effect can prevent the screwing sleeve from rotating on the connecting body by itself, so that the loose-proof effect can be surely achieved.

### BRIEF DESCRIPTION OF THE DRAWINGS

FIG. 1 is an exploded perspective view of the present invention;

FIG. 2 is an assembled perspective view of the present invention;

FIG. 3 is a cross-sectional view of the present invention;

FIG. 4 is a cross-sectional view taken along the line 4-4 in FIG. 3;

FIG. 5 is a partially enlarged view showing the portion A in FIG. 4;

FIG. 6 is an exploded perspective view showing the present invention and a socket;

FIG. 7 is a cross-sectional view showing the assembly of the present invention with the socket;

FIG. 8 is an exploded perspective view showing the present invention and another embodiment of the socket; and

FIG. 9 is a cross-sectional view showing the assembly of the present invention with another embodiment of the socket.

### DETAILED DESCRIPTION OF THE INVENTION

In order to make the Examiner to better understand the characteristics and technical contents of the present invention, a detailed description will be made with reference to the accompanying drawings. However, it should be understood that the drawings are illustrative only but not to limit the scope of the present invention.

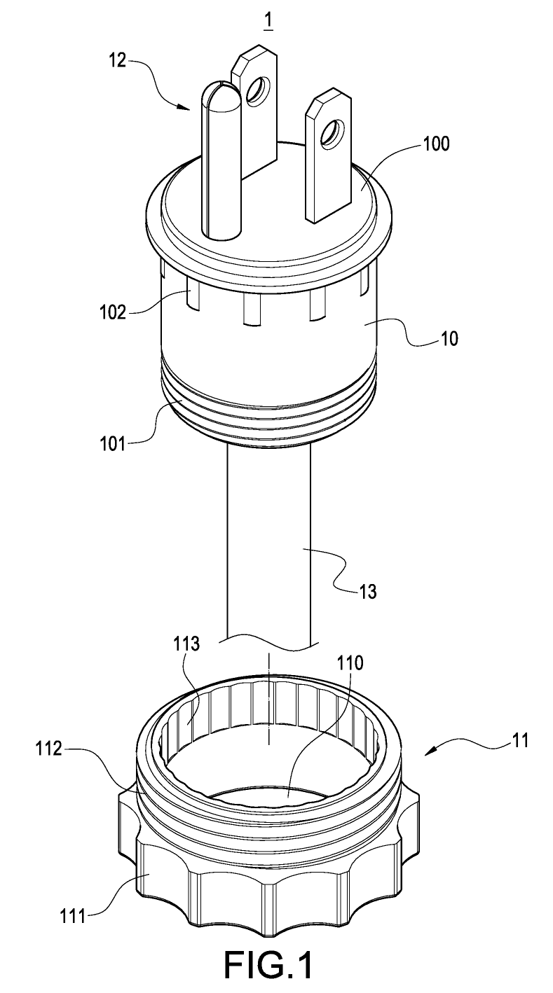

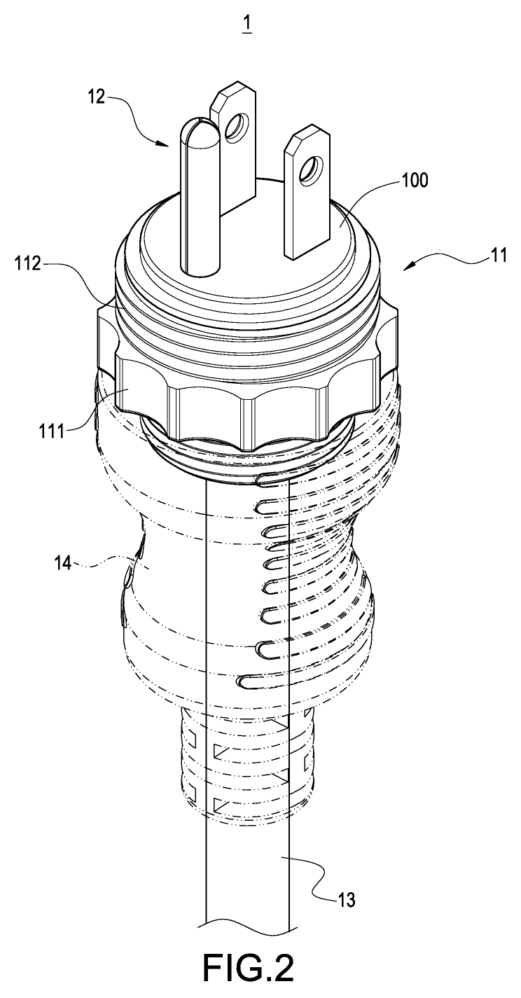

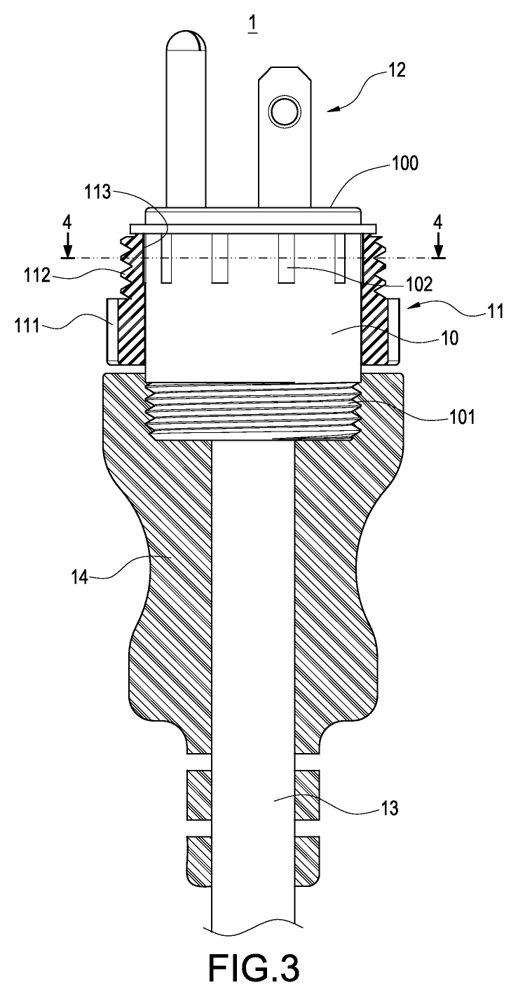

FIGS. 1, 2, and 3 are the exploded perspective view, the assembled view and the cross-sectional view of the present invention respectively. The present invention provides a loose-proof connector including a connecting body 10 and a screwing sleeve 11 connected to the outside of the connecting body 10.

In the illustrated embodiment of the present invention, the connecting body 10 is formed into a plug or a male connector. A front end face 100 of the connecting body is provided with insertion terminals 12. The insertion terminals 12 extend into the connecting body 10 through the front end face 100 thereof, and are electrically connected (not shown) with an electric line 13. Then, the electric line 13 extends out of the rear end of the connecting body 10.

The screwing sleeve 11 is formed into an annular body and has a circular through hole 110 that allows the connecting body 10 to be inserted therein with the screwing sleeve 11 rotating freely at the outside of the connecting body 10. The screwing sleeve 11 is circumferentially provided with wavelike gripping portions 111 that allow the screwing sleeve to be rotated by hands easily. The screwing sleeve 111 is provided with outer threads 112 adjacent to the front end thereof When the screwing sleeve 11 is located at the outside of the connecting body 10, a flexible cushioning piece 14 is further covered between the rear end of the connecting body 10 and the front end of the electric line 13, thereby preventing the electric line 13 from being bent and preventing the screwing sleeve 11 from being released from the rear end of the connecting body 10. Outer threads 101 can be additionally provided at a position adjacent to the rear end of the connecting body 10, thereby increasing the engagement between the connecting body and the cushioning piece 14 and having a better connection.

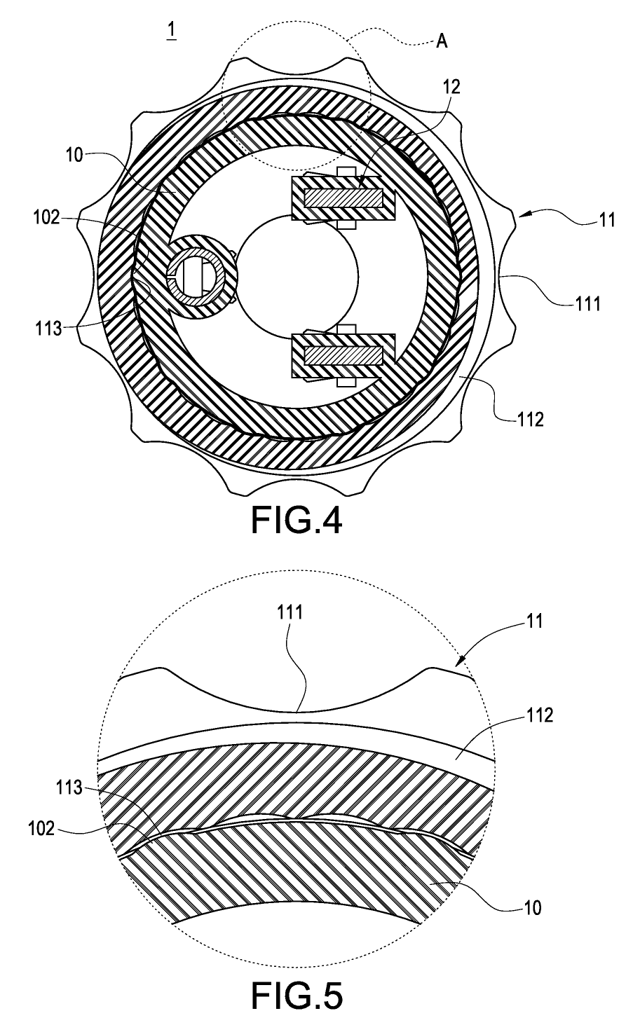

As shown in FIGS. 4 and 5, in the present invention, the inner wall of the circular through hole 110 of the screwing sleeve 11 is provided with a plurality of recessed arcs 113 that are arranged circumferentially. On annular band of the outside of the connecting body 10 is provided with at least one protruding arcs 102. The protruding arcs 102 exactly oppose to any one of the recessed arcs 110 and thus are adjacent thereto without contacting, thereby maintaining the screwing sleeve 11 to rotate on the outside of the connecting body 10. When the screwing sleeve 11 rotates on the outside of the connecting body 10, the protruding arcs 102 can bounce between any two adjacent recessed arcs 113 so as to generate a small locking effect. In other words, when the screwing sleeve 11 rotates without any external force, the locking effect between the protruding arcs 102 and each recessed arc 113 can prevent the screwing sleeve 11 from rotating on the outside of the connecting body 10 by itself.

Therefore, with the above arrangement, the loose-proof connector of the present invention can be achieved.

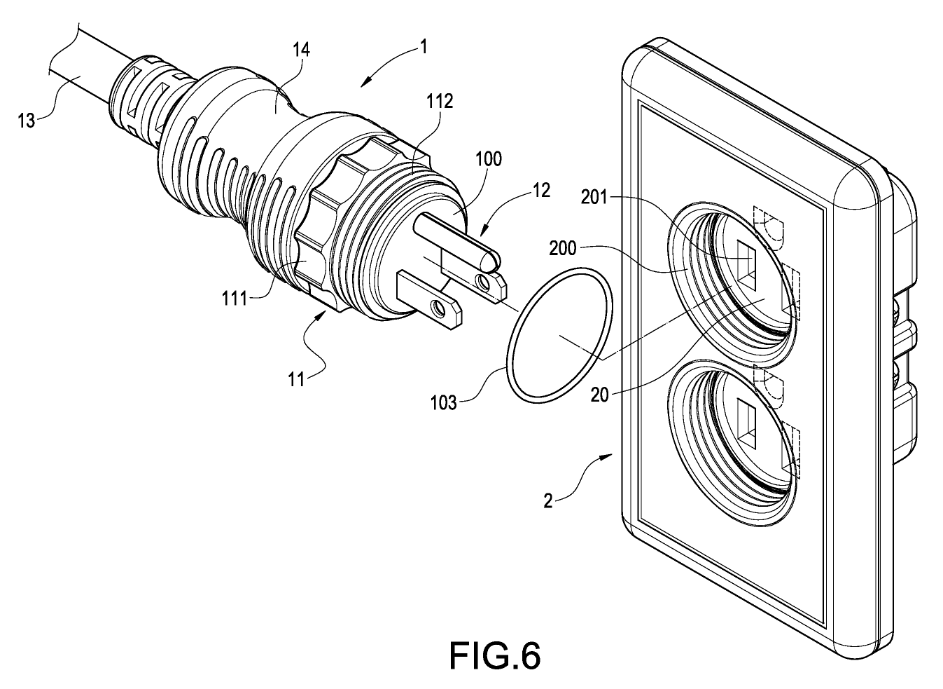

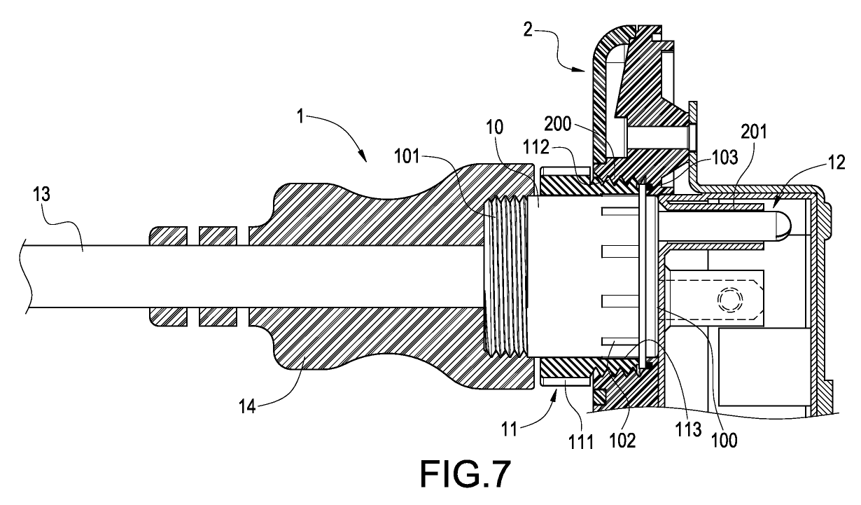

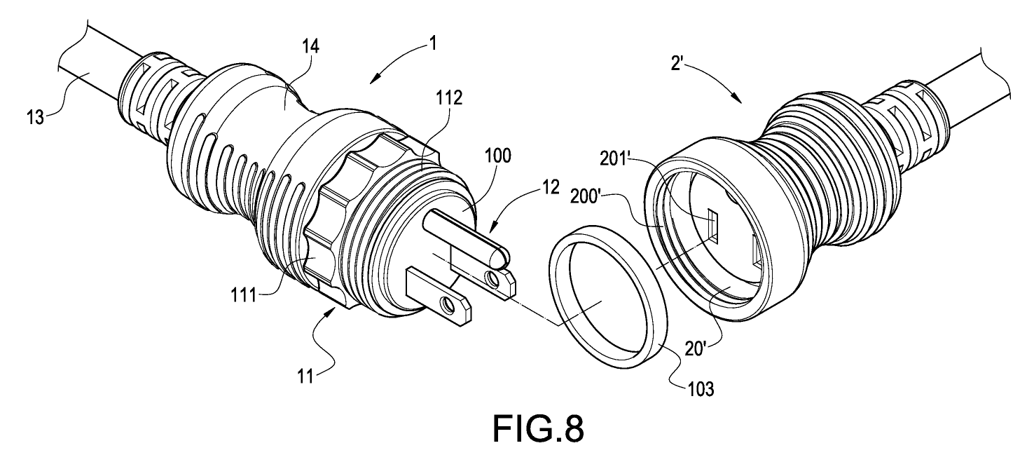

As shown in FIGS. 6 and 7, when the connecting body 10 in a form of a plug is inserted into an insertion hole 20 of an associated socket 2, after the insertion terminals 12 of the connecting body 10 are inserted into insertion slots 201 of the insertion hole 20, the outer threads 112 of the screwing sleeve 11 are threadedly connected with the inner threads 200 on the inner edge of the insertion hole 20, so that the connecting body 10 can be further screwed on the insertion hole 20. Further, since the protruding arcs 102 and the recessed arcs 113 are engaged with each other, the outer threads 112 of the screwing sleeve 11 and the inner threads 200 can be prevented from rotating reversely due to the external factors such as vibration. As a result, the problem of the loosening of the connector can be prevented efficiently.

As shown in FIG. 7, in the connecting body 10, the outer edge of the front end face 100 of the connecting body 10 on which the insertion terminals 12 are provided is additionally provided with a waterproof gasket 103, thereby providing a waterproof effect after the connecting body 10 is inserted into the insertion hole 20.

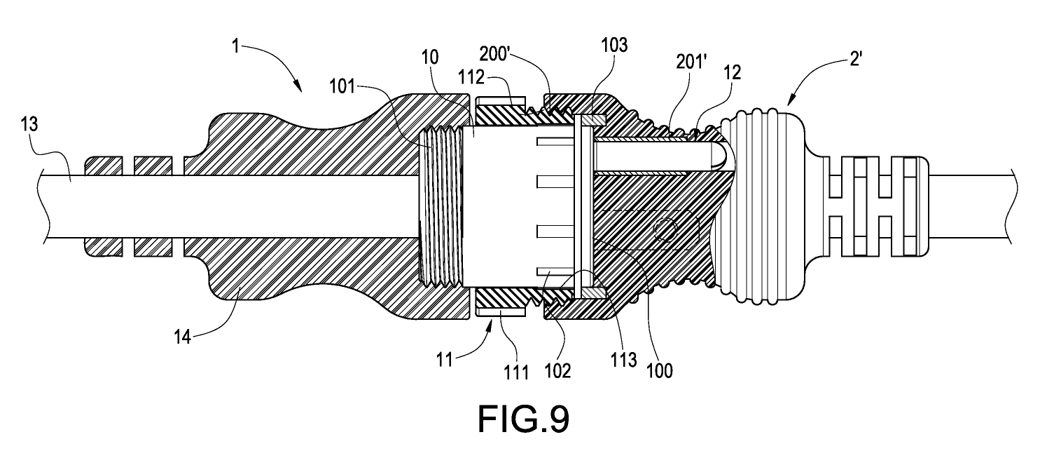

Furthermore, as shown in FIGS. 8 and 9, in the present embodiment, the socket 2 can be formed into a female connector and also has an insertion hole 20′, inner threads 200′ on the inner edge of the insertion hole 20′, and insertion slots 201′ in the insertion hole 20′, which are the same as those in the previous embodiment. Via this arrangement, it is convenient to connect with the connector 1.

According to the above, the present invention can solve the drawbacks of prior art and achieve the expected purposes. Further, it indeed involves novelty and inventive steps and thus conforms to the requirements for an invention patent.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A loose-proof connector, comprising:
a screwing sleeve being formed into an annular body and having a circular through hole, an inner wall of the circular through hole being provided with a plurality of recessed arcs that are arranged circumferentially; and
a connecting body being inserted into the circular through hole of the screwing sleeve, an annular band of the connecting body being provided with projecting arcs to correspond to each recessed arc, the protruding arcs opposing to any one of the recessed arcs and being adjacent thereto;
wherein when the screwing sleeve rotates on the connecting body, the protruding arcs bounce between any two adjacent recessed arcs so as to generate a locking effect.

2. The loose-proof connector according to claim 1, wherein the connecting body is a plug or a male connector.

3. The loose-proof connector according to claim 2, wherein the connecting body has protruding insertion terminals, and an outer edge of an end face of the connecting body from which the insertion terminals protrude is provided with a waterproof gasket.

4. The loose-proof connector according to claim 2, wherein the connecting body has protruding insertion terminals, the insertion terminals extend into the connecting body and are electrically connected with an electric line, and the electric line extends to outside from the other end face of the connecting body.

5. The loose-proof connector according to claim 4, wherein the insertion terminals extend into the connecting body and are electrically connected with an electric line, and the electric line extends to the outside from the other end face of the connecting body.

6. The loose-proof connector according to claim 5, wherein a flexible cushioning piece is covered on the connecting portion of the connecting body and the electric line.

7. The loose-proof connector according to claim 1, wherein the screwing sleeve is circumferentially provided with wavelike gripping portions that allow the screwing sleeve to be gripped and thus rotated by hands.

8. A loose-proof connector for connecting with a socket, the socket having an insertion hole, and an inner edge of the insertion hole being provided with inner threads, the connector comprising:
a screwing sleeve formed into an annular body and having a circular through hole, an inner wall of the circular through hole being provided with a plurality of recessed arcs that are arranged circumferentially, the screwing sleeve being provided adjacent to a front end thereof with outer threads for threadedly connecting with inner threads of the insertion hole; and
a connecting body inserted into the circular through hole of the screwing sleeve and inserted in the insertion hole, an annular band of the connecting body being provided with projecting arcs to correspond to each recessed arc, the protruding arcs opposing to any one of the recessed arcs and being adjacent thereto;
wherein when the screwing sleeve rotates on the connecting body, the protruding arcs bounce between any two adjacent recessed arcs so as to generate a locking effect.

9. The loose-proof connector according to claim 8, wherein the connecting body is a plug or a male connector.

10. The loose-proof connector according to claim 9, wherein the connecting body has protruding insertion terminals, and an outer edge of an end face of the connecting body from which the insertion terminals protrude is provided with a waterproof gasket.

11. The loose-proof connector according to claim 9, wherein the connecting body has protruding insertion terminals, the insertion terminals extend into the connecting body and are electrically connected with an electric line, and the electric line extends to outside from the other end face of the connecting body.

12. The loose-proof connector according to claim 11, wherein the insertion terminals extend into the connecting body and are electrically connected with an electric line, and the electric line extends to the outside from the other end face of the connecting body.

13. The loose-proof connector according to claim 12, wherein a flexible cushioning piece is covered on the connecting portion of the connecting body and the electric line.

14. The loose-proof connector according to claim 8, wherein the screwing sleeve is circumferentially provided with wavelike gripping portions that allow the screwing sleeve to be gripped and thus rotated by hands.
